(19) United States
(12) Patent Application Publication
(10) Pub. No.: US 2016/0042393 A1
(43) Pub. Date: Feb. 11, 2016

(54) FACILITATING CLIENT-SIDE MANAGEMENT OF ONLINE ADVERTISING INFORMATION, SUCH AS ADVERTISING ACCOUNT INFORMATION

(71) Applicant: Google Inc., Mountain View, CA (US)

(72) Inventors: Elan Dekel, New York, NY (US); Darren Delaye, San Francisco, CA (US); Matthew Hiller, New York, NY (US); Art Komninos, Woodbury, CT (US); Igor Tandetnik, Forest Hills, NY (US); Alan Warren, Pound Ridge, NY (US)

(21) Appl. No.: 14/920,567

(22) Filed: Oct. 22, 2015

Related U.S. Application Data
(63) Continuation of application No. 11/338,423, filed on Jan. 24, 2006.

(51) Int. Cl. G06Q 30/02

(52) U.S. Cl. CPC G06Q 30/0256

(57) ABSTRACT

A client-side editing application allows advertisers and/or customer service representatives to easily and efficiently view, navigate, and edit ad accounts, even those with large numbers of campaigns, ad_groups, keywords and ad creatives. Information viewable in a user interface screen may be limited in scope by a node selection of a hierarchical tree representation of ad account information and limited in type by a tab selection. Ad information, represented in table rows, may be cut, copied and/or moved among different ad groups and ad campaigns.

### CROSS-REFERENCE TO RELATED APPLICATION

The present application claims priority to and is a continuation application under 35 U.S.C. §120 of U.S. patent application Ser. No. 11/338,423, filed on Jan. 24, 2006 and titled “Facilitating Client-Side Management of Online Advertising Information, Such as Advertising Account Information”, which is incorporated herein by reference in its entirety.

### BACKGROUND OF THE INVENTION

1. Field of the Invention

The present invention concerns advertising, such as online advertising for example. In particular, the present invention concerns managing online advertisement (ad) information, such as ad campaign information.

2. Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular. Some online advertisers manage numerous online ads. Consider, for example, a store such as WalMart, which sells various products in various departments. Ads corresponding to different products will likely have different ad creatives (i.e., that which is ultimately rendered to end users), may be of different value to WalMart, and may be targeted to different types of Web pages and/or search queries. Although some advertising systems such as AdWords and Ad Sense from Google provide sophisticated, Web-based, front-end user interfaces for advertisers to manage their ad campaigns, such tools might not meet all of the needs and desires of advertisers that have a large number of ads and/or ad information, and/or that actively manage their ads.

Currently, some of the largest customers of AdWords use Microsoft Excel spreadsheets (referred to as “bulksheets below”) to manage their AdWords campaigns, as the Web-based front-end user interface may be considered to be too cumbersome to view and edit accounts with a large number of campaigns, ad_groups, keywords, and ad creatives. More specifically, users can download a “snapshot” of their ad campaign information and revise this information, in the form of a spreadsheet, offline. When the user is satisfied with their changes, they can then upload the revised information so that the changes become effective. Unfortunately, the complexity and free-form nature of bulksheets leads to a high rate of user generated errors. Consequently, nearly all bulksheets need to be reviewed by a Google customer service representative before loading. This, in turn, leads to higher customer support costs, advertiser frustration, and a significant time lag between submission of an edited bulksheet and when its changes become effective in an online ad account.

In view of the foregoing, it would be useful to provide an application, and preferably a cross-platform desktop application, which would allow users to navigate, view, create and edit information of large advertising accounts easily. It would be useful to provide at least similar, if not the same, functions offered by current techniques for managing online advertising accounts, e.g., bulksheets. It would be useful to allow advertisers to import and/or export advertising account information in a way that reduces or eliminates the need for intervention by a customer service representative. It would also be useful to reduce the number and/or frequency of events leading to the need to check the advertising account information against policies, and/or to minimize the amount of information that needs to be checked against policies.

### SUMMARY OF THE INVENTION

Embodiments consistent with the present invention may provide a cross-platform desktop application, to provide a user interface that meets one or more of the foregoing needs. For example, embodiments consistent with the present invention may do so by providing a client-side editing application which allows advertisers and/or customer service representatives to easily and efficiently view, navigate, and edit ad accounts, even those with large numbers of campaigns, ad groups, keywords and ad creatives. Information viewable in a user interface screen may be limited in scope by a node selection of a hierarchical tree representation of ad account information and limited in type by a tab selection. Ad information, represented in table rows, may be cut, copied and/or moved among different ad groups and ad campaigns.

### BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram of exemplary operations that may be performed in a manner consistent with the present invention, as well as information that may be used and/or generated by such operations.

FIGS. 4 and 5 are flow diagrams of exemplary back-end and front-end methods, respectively, for facilitating ad information entry and management (e.g., editing) in a manner consistent with the present invention.

FIGS. 6-10 are exemplary screens of different “tabs” of an exemplary user interface consistent with the present invention.

FIG. 11 is an exemplary screen of an exemplary user interface consistent with the present invention which shows a full ad account scope and a text ad tab selected.

FIG. 12 is an exemplary screen of an exemplary user interface consistent with the present invention which shows full ad account scope and a keywords tab selected.

FIG. 13 is an exemplary screen of an exemplary user interface consistent with the present invention which shows full ad account scope and a campaigns tab selected.

FIG. 14 is an exemplary screen of an exemplary user interface consistent with the present invention which shows an error notification and the ability to make an exception request.

FIG. 15 is an exemplary screen of an exemplary user interface consistent with the present invention which shows full ad account scope with search results for keywords matching the search term “camera”.

FIG. 16 is a block diagram of apparatus that may be used to perform at least some operations, and store at least some information, in a manner consistent with the present invention.

### DETAILED DESCRIPTION

The present invention may involve novel methods, apparatus, message formats, and/or data structures for facilitating the management of online ad information. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

In the following definitions of terms that may be used in the specification are provided in §4.1. Then, environments in which, or with which, the present invention may operate are described in §4.2. Exemplary embodiments of the present invention are described in §4.3. Thereafter, specific examples illustrating uses of exemplary embodiments of the present invention are provided in §4.4. Finally, some conclusions regarding the present invention are set forth in §4.5.

### DEFINITIONS

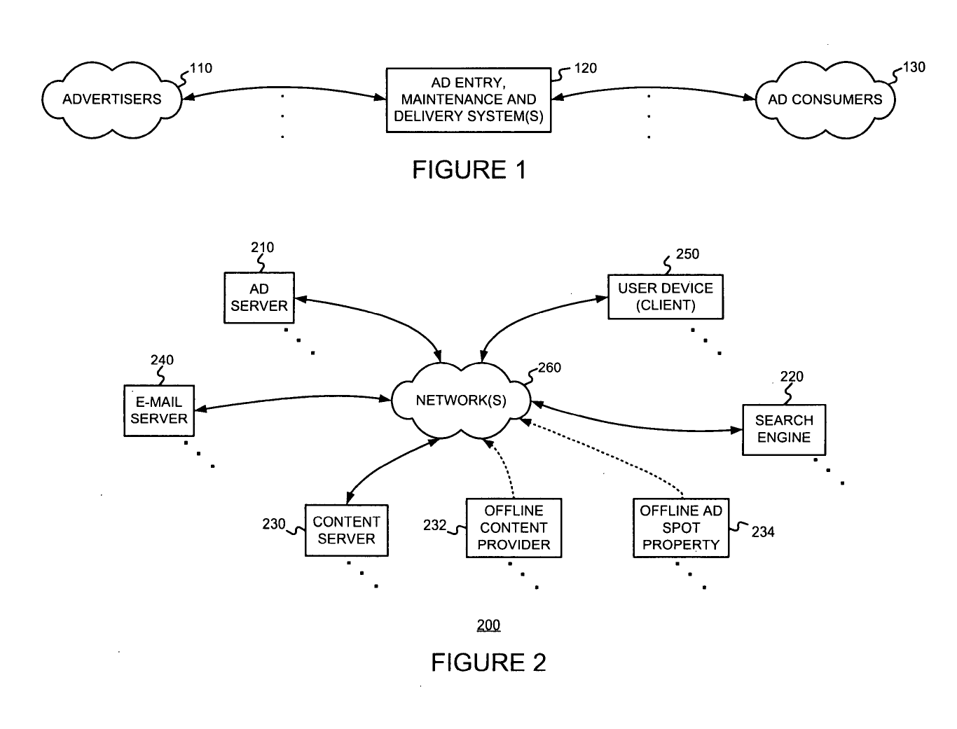

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program; spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

Exemplary Advertising Environments in which, or with which, the Present Invention May Operate

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### Exemplary Embodiments

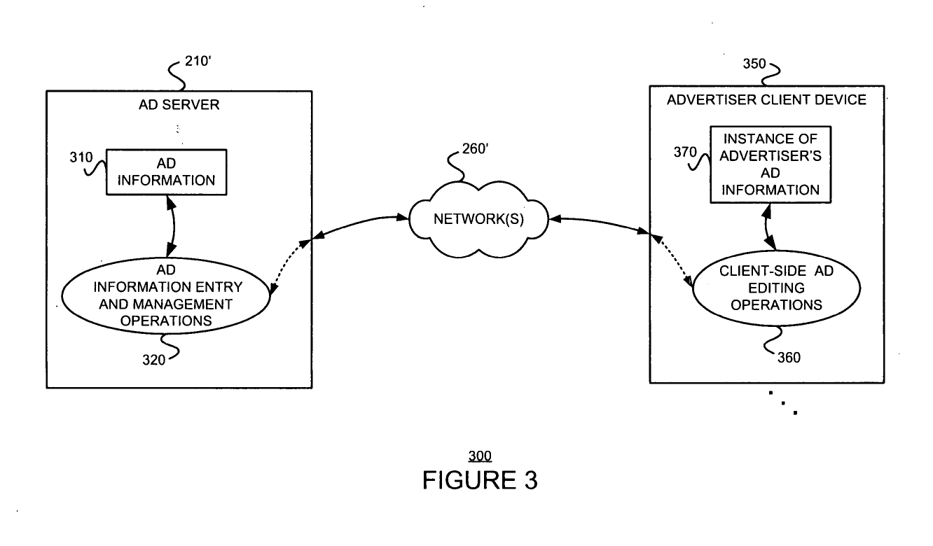

FIG. 3 is a bubble diagram of exemplary operations that may be performed in a manner consistent with the present invention, as well as information that may be used and/or generated by such operations. An ad server 210′ and an advertiser client device 350 may communicate with one another via one or more networks 260′, such as the Internet for example. The ad server 210′ may include stored ad information 310 and ad information entry and management operations 320. The ad server 210′ may include various other operations, not shown, such as ad serving, ad relevancy determination, ad scoring, ad performance tracking, accounting, billing, ad targeting assistance, etc. The advertiser client device 350 may include a stored instance of the advertiser's ad information 370 and client-side (local) ad editing operations 360.

As one skilled in the art will appreciate, the ad information entry and management operations 320 may be thought of as “back-end” operations, while the client-side ad editing operations 360 may be thought of as “front-end” operations. The client-side ad editing operations 360 may be run “offline” such that a connection with the ad server 210′ is not required when editing ad account information.

### Exemplary Methods

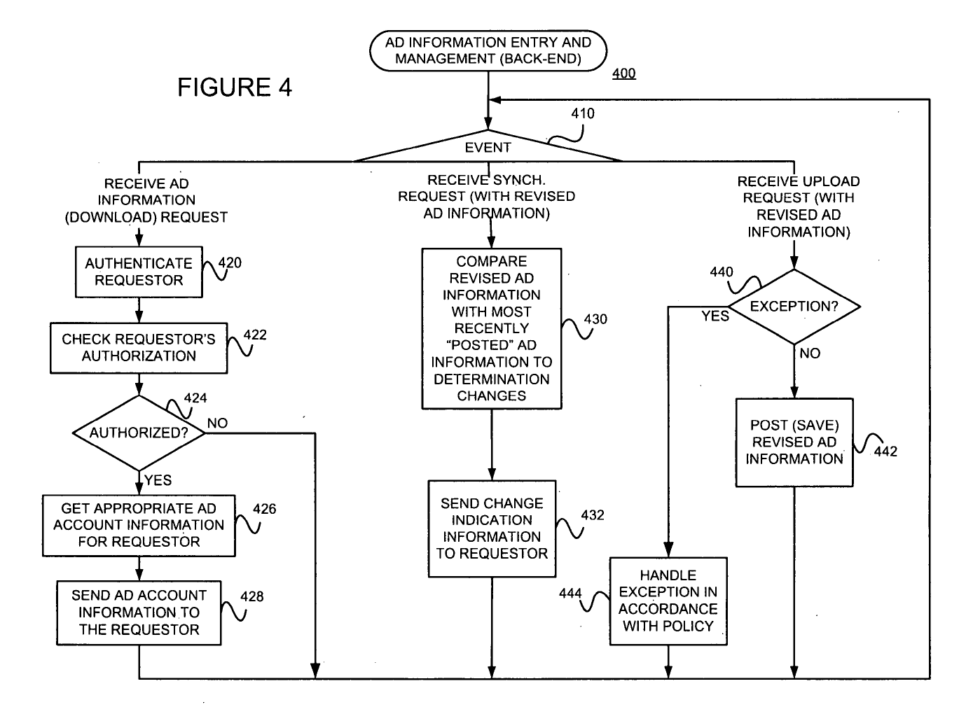

FIG. 4 is a flow diagram of an exemplary back-end method 400 for facilitating ad information entry and management in a manner consistent with the present invention. Various branches of the method 400 may be performed in response to various events. (Block 410) For example, if an ad information (e.g., download) request is received, the requestor may be authenticated. (Block 420) If the requestor is authorized (Blocks 422 and 424), the appropriate account information for the requestor is obtained (Block 426) and sent to the requestor (Block 428) before the method 400 branches back to event block 410. Referring back to decision block 424, if the requestor is not authorized to access the requested ad information, the method 400 branches back to event block 410, perhaps subject to certain exception handling (not shown).

Referring back to event block 410, if a synchronization request (with revised ad information) is received, the revised ad information is compared with the most recently posted (e.g., committed) ad information to determine changes (Block 430) and change indication information is sent to the requestor (Block 432) before the method 400 branches back to event block 410.

Referring back to event block 410, if an upload request (with revised ad information) is received, if there are no exceptions, the revised ad information is posted (e.g., committed) (Blocks 440 and 442) before the method 400 branches back to event block 410. If, on the other hand, there is an exception, the exception is handled in accordance with exception handling policies (Blocks 440 and 444) before the method branches back to event block 410.

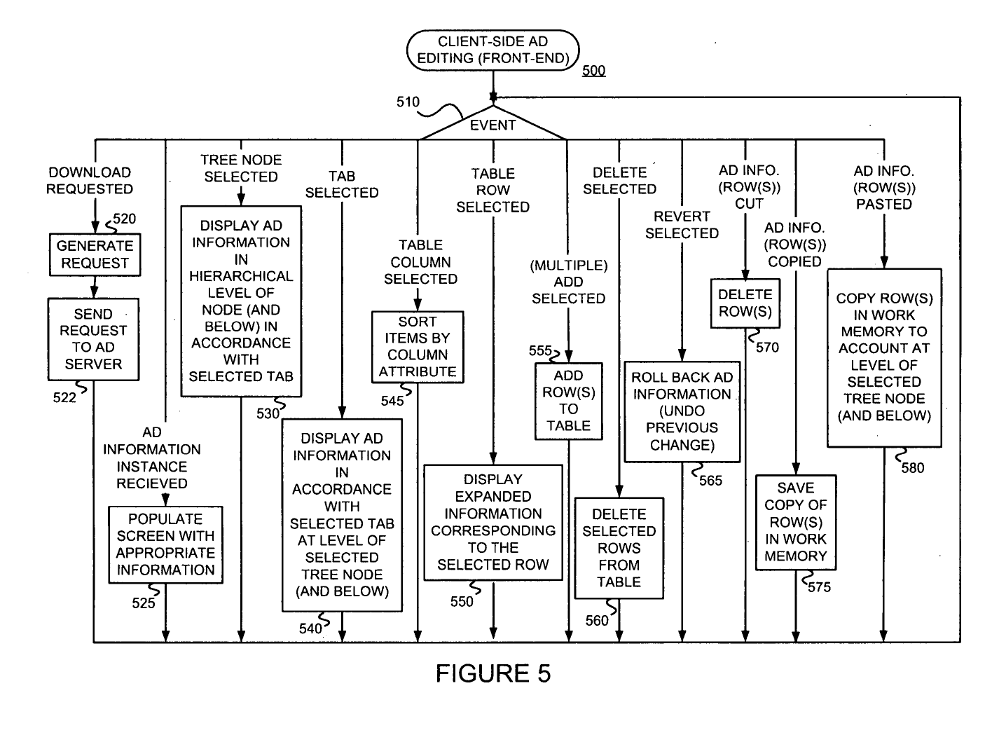

FIG. 5 is a flow diagram of an exemplary front-end method 500 for facilitating client-side ad information editing in a manner consistent with the present invention. Various branches of the method 500 may be performed in response to various events. (Block 510) For example, if a download (of ad account information) is requested (e.g., by a user input), a request is generated (Block 520) and sent to the ad server (e.g., the back-end operations) (Block 522) before the method 500 branches back to event block 510.

If an instance of the ad account information is received, the display screen of the local client device is populated with appropriate information (Block 525) before the method 500 branches back to event block 510.

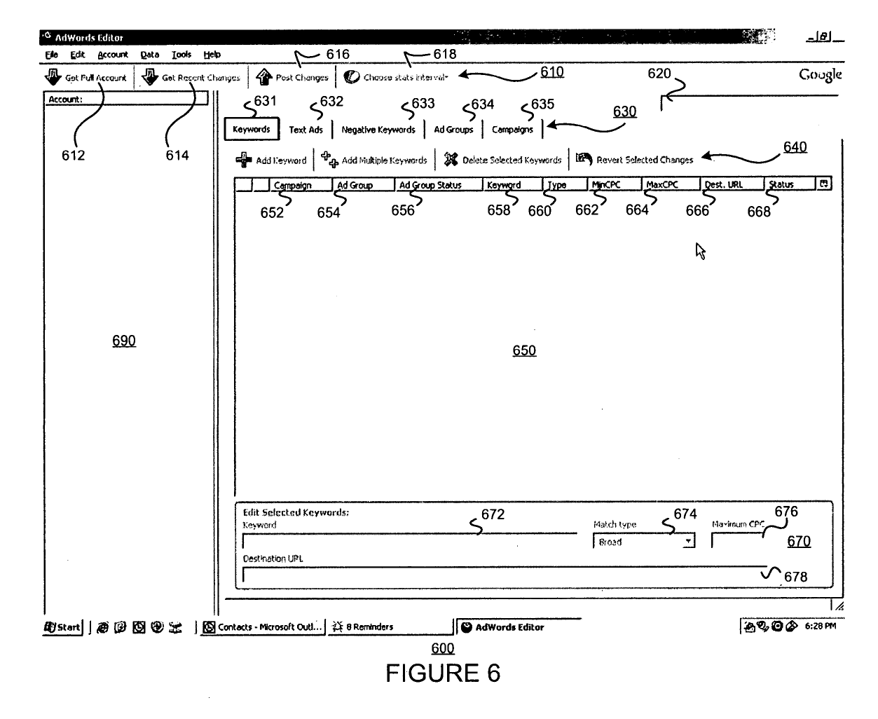

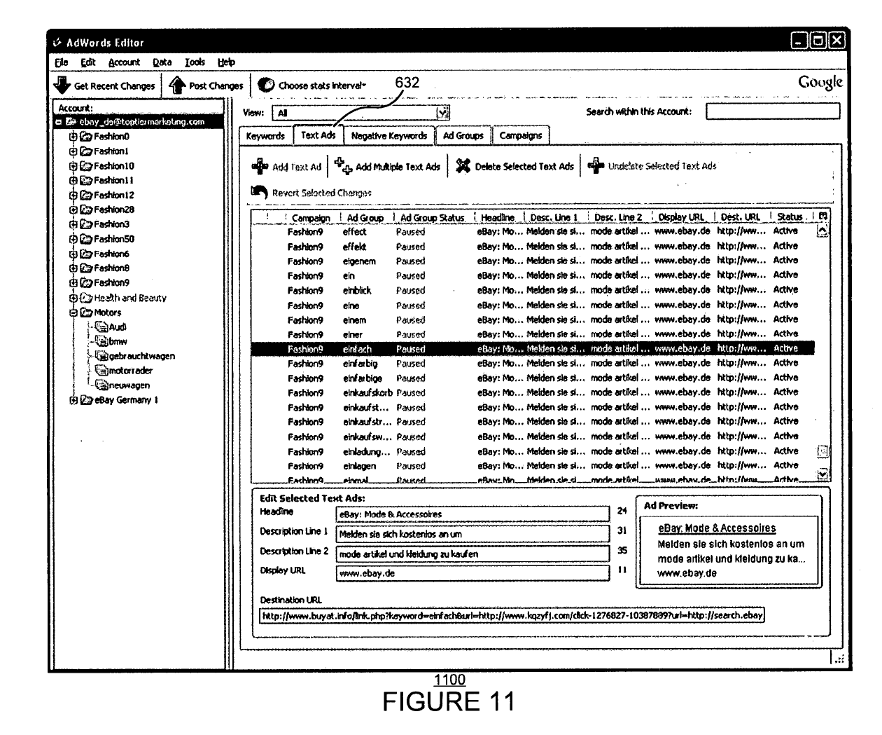

If a tree node (e.g., corresponding to an ad campaign or ad campaign+ad group) is selected, ad information in the hierarchical level of the selected node (and below) is displayed in accordance with a selected (or default) tab (Block 530) (See, e.g., FIGS. 11-15, described below), before the method 500 branches back to event block 510. Similarly, if a tab is selected (See, e.g., 630-635 of FIGS. 6-10, described below), ad information is displayed in accordance with the selected tab at a level of a selected (or default) tree node (and below) (Block 540) before the method 500 branches back to event block 510.

If a table column is selected, rows in a table view (See, e.g., 650, 750, 850, 950 and 1010 of FIGS. 6-10, respectively, described below) are sorted by the column attribute (Block 545) before the method 500 branches back to event block 510.

If a table row is selected, expanded information corresponding to the selected row may be displayed and made available for editing (Block 550) before the method 500 branches back to event block 510.

If an add (or multiple) add is selected, one (or more) rows are added to the table (Block 555) before the method 500 branches back to event block 510. If a delete is selected, then one or more selected rows are deleted from the table (Block 560) before the method 500 branches back to event block 510. If a revert operation is selected, ad information is rolled back to a previous instance (e.g., a previous change is undone) (Block 565) before the method 500 branches back to event block 510. If ad information (e.g., row(s)) is cut, the cut row(s) is deleted (Block 570) before the method 500 branches back to event block 510. If ad information (e.g., row(s)) is copied, then a copy of selected ad information is saved to work memory (Block 575) before the method 500 branches back to event block 510. Finally, if ad information (e.g., row(s)) is pasted, the ad information (e.g., row(s)) saved in work memory are copied to the ad account at the level of the selected (or default) tree node (and perhaps below) (Block 580) before the method 500 branches back to event block 510.

### Exemplary User Interface Display Screens

FIGS. 6-10 are exemplary screens corresponding to different “tabs” of an exemplary user interface consistent with the present invention. Generally, a set of buttons 610 allows a user to get full ad account information (button 612) (e.g., download ad account information), get recent ad account changes (button 614), post ad account changes (button 616) (e.g., upload ad account information), and chose an interval over which to show statistics (button 618).

Drop down menus for “file” features, “edit” features, “account” features, “data” features, “tools” features, and “help” features are provided above the set of buttons 610.

An account portion 690 of the display includes a hierarchical view of ad account information. To the right of the ad account portion 690 are a search box 620 and a set 630 of tabs. The set 630 of tabs includes a “keywords” tab 631, a “text ads” tab 632, a “negative keywords” tab 633, an “ad_groups” tab 634, and a “campaigns” tab 635. The type of contents of an information table (or grid) 650/750/850/950/1050, as well as the type of buttons 640/740/840/940/1040 shown above the information table and the type of expanded table information 670/770/870/970/1070 shown below the information table will likely depend on the particular tab 630 selected. The contents (scope and type) of the information table will depend on both the type of information corresponding to the tab 630 selected and the scope of information corresponding to the level of the hierarchical ad account tree node selected. The expanded table information may be used to enter new information and/or to edit existing information (e.g., corresponding to one or more rows of the information table).

### Tree View

Within the account box 690, a left-to-right tree hierarchy might show: Account->Campaigns->Ad_groups, and allow easy navigation between accounts, campaigns, and ad_groups. Selecting (e.g., clicking on) either an Account, a Campaign, or an Ad_group, will change the current view displayed in the tabbed pane to the right of the account box 690. For example, clicking on an ad_group, results in showing the data in that ad_group, while clicking on a campaign or an account, shows all the data in that campaign or account, respectively. The user can copy-paste ad_groups and campaigns between open accounts.

### Tabs

As shown, some embodiments consistent with the present invention provide a user interface screen with tabs for each of the editable elements in an ad account. For example, there might be tabs for Keywords 631, Text Ads 632, Negative Keywords (for campaign level negative keywords) 633, Ad_groups 634, and Campaigns 635.

In some embodiments consistent with the present invention, tab titles might include the number of items in the tab, e.g. “Keyword (53)”.

Although not shown, additional tabs might be provided for one or more of Image Ads, Website Inclusion/Exclusion, etc.

### Keyword Tab

FIG. 6 illustrates an exemplary user interface screen 600 in which the Keywords tab 631 has been selected. The information table 650 lists all the keywords in the current view (apart from the scratch pad), corresponding to the scope of the selected portion of the ad account tree hierarchy in portion 690. In the exemplary embodiment depicted, the information table 650 may include columns for campaign information 652, ad group information 654, ad group status information 656, the keyword 658, the keyword type 660, a minimum offer per selection (e.g., cost per click or CPC, e.g., as determined by the ad serving system to allow poorly performing ads to compete to be served) 662, a maximum CPC 664, an ad landing page (e.g., as defined by a destination URL) 666, and status information 668. The status information 668 might include a change status, such as added “+”, deleted “−”, changed “delta”, or blank, whether the keyword is active or in active, etc. The status information might also include “move to” and “move from” indicators to show that the keyword existed previously, but is now just moved to a new location. (This is a delete/create database operation, but is useful from a user interface standpoint.)

Although not shown, at least some embodiments consistent with the present invention might include one or more of the following columns showing statistics corresponding to a selected date range: clicks; impressions; selection rate (e.g., click-through rate or CTR); average CPC; cost; etc.

Although not shown, at least some embodiments consistent with the present invention might include one or more of the following columns with specified mathematical relationships to other columns, to enable common calculations. Such common calculations might include one or more of: conversion rate (If the user is using conversion tracking, this data should be downloaded. Otherwise the user can enter their own data); margin (per conversion) (The user can enter their own data); profit (e.g., (Conversions*Margin)−(Cost)); number of conversions; number of transactions; cost per action (CPA); eturn on advertising spend (ROAS); etc.

As indicated by the two left-most buttons of the set 640, a user should be able to add one or more keywords. In at least some embodiments consistent with the present invention, the user might be allowed to add keywords if they are in an ad_group view (they have clicked on an ad_group in the tree-view), or in a scratch pad. In at least some embodiments consistent with the present invention, if the user has clicked on a campaign or account view, or a custom view, then the user should not be permitted add keywords to the keyword grid. The user can add keywords, for example, by selecting the “add keyword” button (+), pasting a row of keywords into Add Multiple dialog (++), and/or using an Import Wizard (described below).

In at least some embodiments consistent with the present invention, the import wizard is similar to multiple add, except for the following. First the entered rows must have campaign and ad_group columns, and is not tied to the scope of one ad_group. Second, if the campaign/ad_group does not exist, it may be verified that the user wants to create them. If so, they may be created without any campaign settings, the keywords (and/or creatives) may be dumped into the created campaign/ad_group, and the campaign may be marked with a warning (i.e. incomplete campaign parameters). Third, the result view contains new items and existing items. (For the existing items, each row might also identify which ad_group and campaign the keyword is in, as the keyword may be matched to multiple keywords in multiple ad_groups. Fourth, for new keywords, the user can specify a campaign+ad_group in which they will all be dumped. Fifth, for new creatives, the user can specify a campaign/ad_group in which they will all be dumped.

In at least some embodiments consistent with the present invention, keyword information may be modified as follows. The user can select one or more keywords within a view, and apply changes to all of them at once. As indicated in expanded table information section (also referred to as an “editing pane”) 670, changes can be made to Keyword Type (e.g., broad, strict, phrase, etc.) 674, Maximum CPC 676 and/or Destination URL 678. While the user is entering text, all the visible selected items in the data table will mirror the values in the edit field(s). The changes might be made under one or more conditions such as, for example, on blur (click outside of box), on enter key press, after X (e.g., 3 or 4) seconds, etc.

As described below, in at least some embodiments consistent with the present invention, the user can also perform Advanced CPC changes and/or Advanced URL changes.

### Text Ads Tab

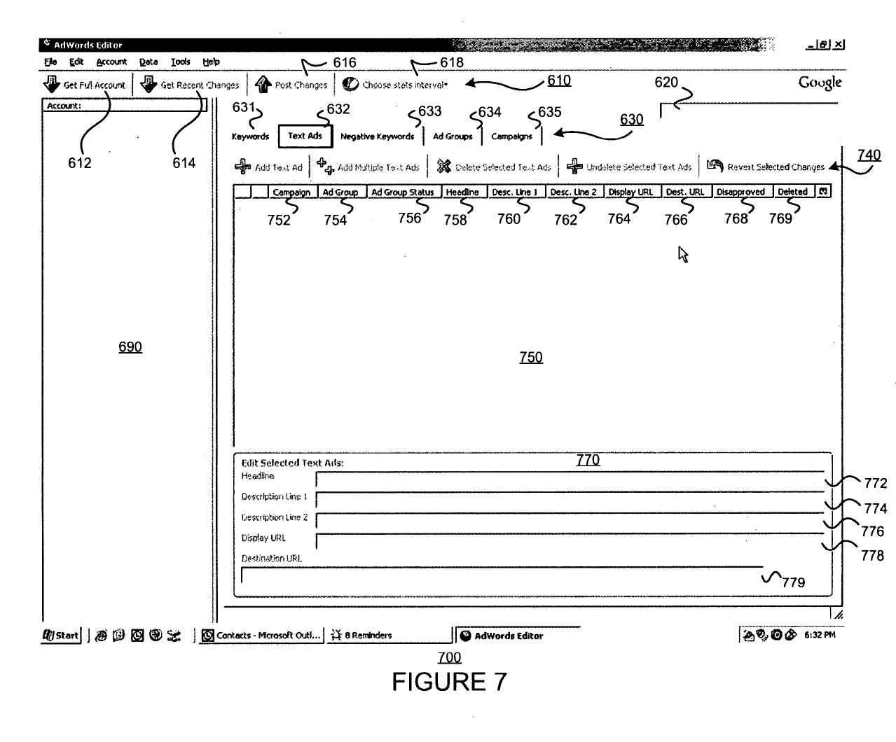

FIG. 7 illustrates an exemplary user interface screen 700 in which the Text Ads tab 632 has been selected. The information table 750 lists all the text ads in the current view (apart from the scratch pad), corresponding to the scope of the selected portion of the ad account tree hierarchy in portion 690. In the exemplary embodiment depicted, the information table 750 may include columns for campaign information 752, ad group information 754, ad group status information 756, text ad headline 758, text ad first description line 760, text ad second description line 762, text ad display URL 764, ad landing page (e.g., destination URL) 766, whether or not disapproved 768, and whether or not deleted 769. One or more additional columns, such as those described above with reference to the keywords tab 632, might be provided.

As indicated by buttons 740, ads can be added, deleted, undeleted, etc.

As indicated by expanded table information portion (or “editing pane”) 770, text ad information such as headline 772, description lines 774 and 776, display URL 778 and destination URL 779, etc., may be added and/or edited.

In at least some embodiments consistent with the present invention, the text ads tab 632 shows all of the creatives in the current view. The user might be permitted to perform mass edits on all selected creatives. For example, the user might be permitted to perform multiple edits on destination URL, Display URL, any selected creative row, etc.

In at least some embodiments consistent with the present invention, the user might be permitted to view and edit text ads in rows, or in boxes. The user might be permitted to toggle between both views.

The “text ad” tab may be thought of more generally as a “ad creatives” tab.

### Negative Keywords

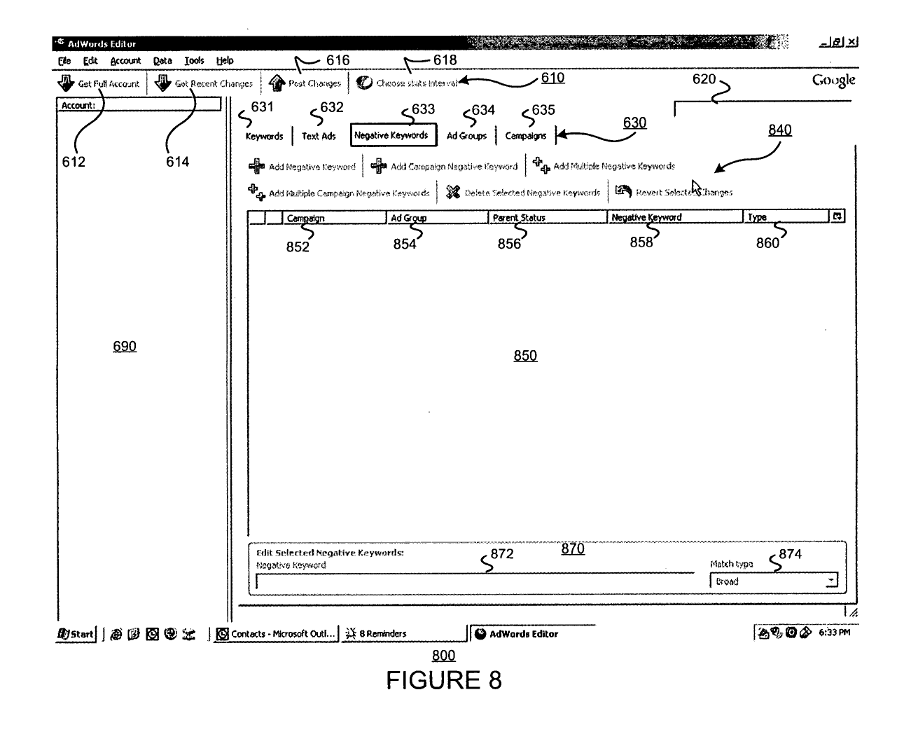

FIG. 8 illustrates an exemplary user interface screen 800 in which the Negative Keywords tab 633 has been selected. The information table 850 lists all the Negative Keywords in the current view (apart from the scratch pad), corresponding to the scope of the selected portion of the ad account tree hierarchy in portion 690. In the exemplary embodiment depicted, the information table 850 may include columns for campaign information 852, ad group information 854, parent status information 856, the negative keyword 858 and the type 860.

In at least some embodiments consistent with the present invention, the user can add Negative Keywords either at the Campaign or Ad_group level. Notice that unlike keywords, negative keywords don't have associated CPCs or Destination URLs.

In at least some embodiments consistent with the present invention, ad_group negative keywords are indicated by the keyword type “Negative”. In at least some embodiments consistent with the present invention, campaign negative keyword are shown in the Negative tab. Ad_group negative keywords might also be shown in the negative keyword tab. Ad_group negative keywords might have an associated ad_group name.

Operations corresponding to buttons 840 may be performed. Negative keyword information, such as the negative keyword itself 872 and the match type 874, etc. may be added and/or edited in portion 870.

### Ad Group Tab

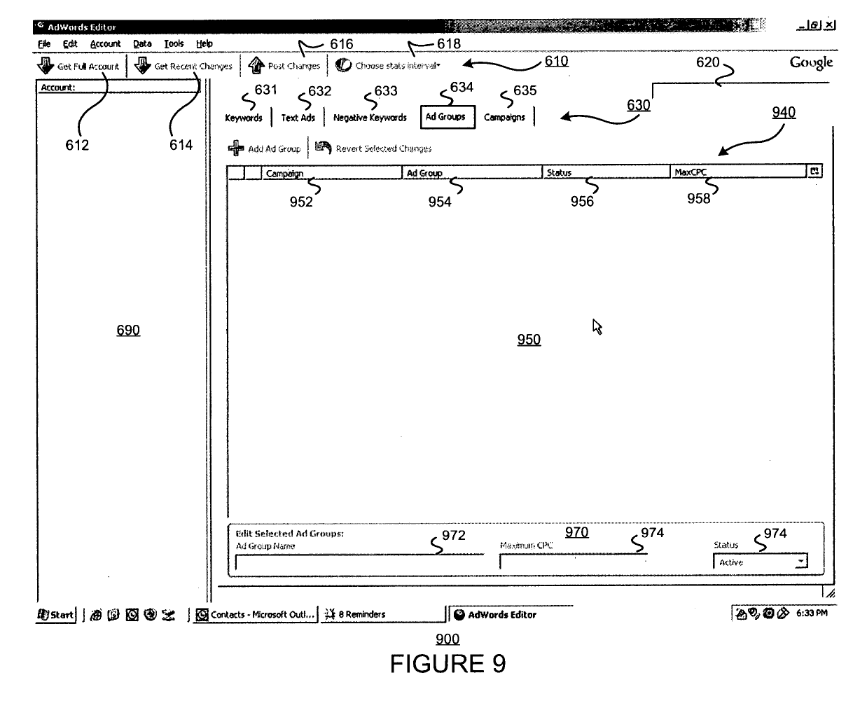

FIG. 9 illustrates an exemplary user interface screen 900 in which the Ad Groups tab 634 has been selected. The information table 950 lists all the ad groups in the current view (apart from the scratch pad), corresponding to the scope of the selected portion of the ad account tree hierarchy in portion 690. In the exemplary embodiment depicted, the information table 950 may include columns for campaign information 952, ad group information 954, status information 956, and a Maximum CPC 958. The table 950 may also include columns (not shown) corresponding to one or more of number of keywords, clicks, selection rate, average CPC, cost, average position, conversion rate, cost per conversion, etc.

Ad group information such as name 972, maximum CPC 974 and/or status 976 may be added and/or edited as shown in expanded table information portion (or “editing pane”) 970. Ad_group settings such as Start/End date, Daily budget, Pause status, etc. may be editable.

### Campaign Tab

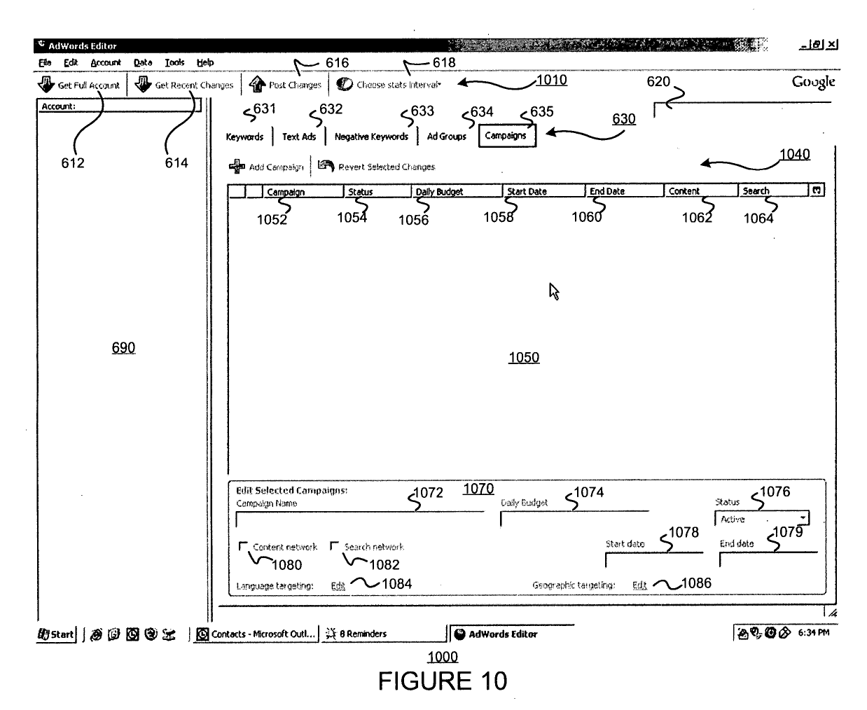

FIG. 10 illustrates an exemplary user interface screen 1000 in which the Campaigns tab 635 has been selected. The information table 1050 lists all the campaigns in the current view (apart from the scratch pad), corresponding to the scope of the selected portion of the ad account tree hierarchy in portion 690. As a practical matter, this may be all of the campaigns under the ad account. In the exemplary embodiment depicted, the information table 1050 may include columns for campaign information 1052, status information 1054, daily budget 1056, start date 1058, end date 1060, whether the campaign is for a Webpage content relevant ad system such as AdSense from Google 1062 and whether the campaign is for a search query relevant ad system such as AdWords from Google 1064. Although not shown, columns for additional information such as geotargeting, language, etc. may be provided. Although not shown, at least some embodiments consistent with the present invention may show one or more campaign statistics such as number of keywords, number of selections, number of impressions, selection rate, average cost per selection, cost, conversion rate, cost per conversion, etc.

Campaign information such as name 1072, daily budget 1074, status 1076, start date 1078, end date 1079, content advertising network (e.g., AdSense from Google) 1080, search advertising network (e.g., AdWords from Google) 1082, language targeting 1084 and/or geographic targeting 1086 may be added and/or edited as shown in expanded table information portion (or “editing pane”) 1070.

In at least some embodiments consistent with the present invention, Language & Geotargeting might appear in the edit pane as:
Languages: Lang1, Lang2, +X Edit (X=additional languages selected)
Locations: Loc1, Loc2, +X Edit (X=additional locations selected)

In at least some embodiments consistent with the present invention, selecting edit opens a modal dialog box. A language modal dialog box allows the user to select multiple languages. A location modal dialog box allows the user to select multiple countries. The location modal dialog box may also allow the user to select a combination of country, metro, city, region, etc.

### Exemplary Apparatus

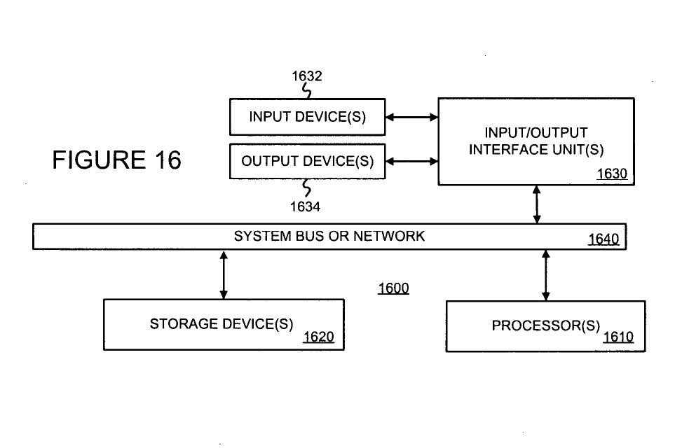

FIG. 16 is a block diagram of apparatus 1600 that may be used to perform at least some operations, and store at least some information, in a manner consistent with the present invention. The apparatus 1600 basically includes one or more processors 1610, one or more input/output interface units 1630, one or more storage devices 1620, and one or more system buses and/or networks 1640 for facilitating the communication of information among the coupled elements. One or more input devices 1632 and one or more output devices 1634 may be coupled with the one or more input/output interfaces 1630.

The one or more processors 1610 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 1620 and/or may be received from an external source via one or more input interface units 1630.

In one embodiment, the machine 1600 may be one or more conventional personal computers. In this case, the processing units 1610 may be one or more microprocessors. The bus 1640 may include a system bus. The storage devices 1620 may include system memory, such as read only memory (ROM) and/or random access memory (RAM). The storage devices 1620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1610 through an appropriate interface 1630 coupled to the system bus 1640. The output devices 1634 may include a monitor or other type of display device, which may also be connected to the system bus 1640 via an appropriate interface. In addition to (or instead of) the monitor, the personal computer may include other (peripheral) output devices (not shown), such as speakers and printers for example.

The operations described above may be performed on one or more computers. Such computers may communicate with each other via one or more networks, such as the Internet for example. Referring back to FIG. 3 for example, the ad server 210′ may be embodied by one or more machines 1600. Similarly, the advertiser client device may be embodied by one or more (but in many cases just one) machines 1600. Local ad editing operations may be performed by a local device executing a local ad editing application (referred to as “the LAEA” without loss of generality)

### Refinements and Alternatives

Exemplary embodiments consistent with the present invention might include one or more of the features described below. Other exemplary embodiments consistent with the present invention might not include such features. Functionality described below (e.g., a user might be permitted to . . . ) might be implemented as computer executable instructions (e.g., as part of the LAEA).

### Tiered Levels of Features/Account Limits

At least some embodiments consistent with the present invention might limit the features available to different groups of users depending on company policy. As one example, copy-paste operations on ad_groups and campaigns between accounts might be limited to customer service representatives (e.g., as server employees or contractors) only. As another example, different accounts might have different values for maximum number of keywords, ad_groups, and campaigns. As yet another example, certain accounts might have access to enhanced features of the advertising network, while others won't.

Some embodiments consistent with the present invention might enforce limits on number of keywords and creatives per Ad_Group. Alternatively, or in addition, a warning may be rendered to the user when an account exceeds the lowest available tier (e.g. 25 campaigns and 50K keywords).

Some embodiments consistent with the present invention might forbid access to cancelled accounts.

### Open Account Dialog

In the specification, a “super account” is an aggregation of ad accounts. Internal (to the ad serving system) customer service is denoted by “ICS”.

In at least some embodiments consistent with the present invention, dialog such as that described here may be used to open an account. The first time the user accesses the LAEA (and any time there is no account snapshot in the local database), the open account dialog will automatically open. In subsequent accesses, upon opening the LAEA, the last accessed account is automatically opened, with the same scope/tab selection as when the LAEA was shut down.

The open account dialog might be accessed from the file menu. It might contain one or more of a list of previously accessed accounts, a button for “add account”, a button for “add super account”, a button for “log in to ICS”, a button for “remove account”, and a “remember me” checkbox (e.g., for non-ICS users).

An ICS user should be able to enter their ICS username and password, and then be able to select an account using its Internal Customer ID or Login Email. An ICS user should also be able to click on a link on ICS (e.g. an laea:// link) which automatically opens up the LAEA with the correct account number filled in to the open account dialog. This is so the ICS user can take advantage of advanced account search options available internally to the ad serving system.

Remove Account operations may include remove open account and remove all accounts.

If super username and password is entered, if it's an super account, a list of children is shown in a new dialog with “add new acct” and “cancel” buttons. When a user selects an account, it gets loaded, and is listed in the account list.

The user should be able to see a list of their recently accessed accounts. For each account, the username and password should be stored so that users can easily access accounts that they regularly work on. The user can choose not to save passwords (e.g., if they don't feel comfortable with the security risks this poses).

The user should be able to edit more than one account and edit them in parallel.

### Get Update/Post/Conflict Resolution

At least some embodiments consistent with the present invention may allow getting updates, posting (e.g., uploading) and resolving conflicts using one or more of the techniques described in this section.

### Get Update

When user clicks on “Download”, a number of acts may be performed. For example, fields which were changed on the server are marked with a green (or some other color) background, and the data from the server is shown. Fields which were changed locally are marked with a purple (or some other color) background and the local data are shown. Finally, fields which were changed in both, are marked with a red (or some other color) background and the data from the server is shown.

After downloading, a new panel may be shown above the tabs 630. The new panel may include one or both of (1) a report of number of new items, or changes to existing items, downloaded, and (2) radio buttons for “on conflict keep my local edits” and “on conflict keep downloaded values”. Initially no radio buttons are set.

At this point, users also have ability to rightclick on an item with a conflict. Rightclick menu will show “revert to previous value” and “revert to local edit”.

Selecting one of the rightmouse options changes it from red background to green or purple (or some other colors).

A “done viewing updates” button may be provided.

### Post

Some embodiments consistent with the present invention might maintain a specific error code(s) per row. All items without errors might be posted (work around items with errors returned during posting). On posting, the user might be notified that the LAEA will not post X items with errors.

In at least some embodiments consistent with the present invention, status reports might be provide before and/or after posting. For example, before posting, the user might be informed:

You are about to post X kws, Y creatives, Z ad_groups, T campaigns, and given the option to post or cancel the posting:

Post your changes to Adwords? [POST] [Cancel]

More detailed status information might include, for example:

You are about to post:
# new campaigns created
# campaigns deleted
# campaigns setting modified
# new ad_groups added
# ad_groups deleted
# ad_groups settings modified
# new kw's added
# kw's deleted
# kw's modified
Per campaign {
   # kw's added
   # kw's deleted
   # creatives added
   # creatives deleted

}
[Post] [Cancel]

As another example, after posting, the user might be informed:
X kws, Y creatives, Z ad_groups, T campaigns were posted successfully, Y were unsuccessful

A more detailed status report might include, for example:
# new errors were discovered and did not post
# new campaigns created
# campaigns deleted
# campaigns setting modified
# new ad_groups added
# ad_groups deleted
# ad_groups settings modified
# new kw's added
# kw's deleted
# kw's modified
Per campaign {
   # kw's added
   # kw's deleted
   # creatives added
   # creatives deleted

}

A progress bar may be provided while posting

### Conflict Resolution

In at least some embodiments consistent with the present invention, conflicting changes may be resolved in accordance with the following decision matrix.

| LAEA | Server | Action |
|---|---|---|
| Orig | Orig | Do Nothing |
| New | New | Do Nothing |
| Deleted | Deleted | Do Nothing |
| Orig | Delta | Server overrides LAEA |
| Orig | Delete | Server overrides LAEA |
| — | New | Server overrides LAEA |
| Delta | Orig | LAEA overrides server |
| Deleted | Orig | LAEA overrides server |
| New | — | LAEA overrides server |
| Deltal | Delta2 | Ask the user |
| Delta | Delete | Ask the user |
| Delete | Delta | Ask the user |

Referring to the last three (3) rows of the decision matrix, when changes exist at both the LAEA and the server, conflicts may be resolved in accordance with a user preference (as evidenced by a radio button selection, a dialog response, etc.).

The following table indicates handling of changes of different intra-row information at the server and the LAEA (e.g., keyword match type changed at server and maxCPC changed at LAEA).

| | | | | Merge the | Merge |
|---|---|---|---|---|---|
| | | Merge the | Merge Server | LAEA over | Server over |
| LAEA | Server | LAEA Only | Only | Server | LAEA |
| Delta Field 1 | Delta Field 1 | Delta Field 1 | Delta Field 1 | Delta Field 1 | Delta Field 1 |
| LAEA | Server | LAEA | Server | LAEA | Server |
| Delta Field 1 | Delta Field 2 | Delta Field 1 | Orig Field 1 | Delta Field 1 | Delta Field 1 |
| LAEA | Server | LAEA | Delta Field 2 | LAEA Delta | LAEA |
| | | Orig Field 2 | Server | Field 2 | Delta Field 2 |
| | | | | Server | Server |

### Archives

In at least some embodiments consistent with the present invention, a user can save archives of their account (e.g., for backup purposes) to their local drive. This archive file might not be user editable (e.g., it might be encrypted). The archive file might be “read only”. The user might be able to leave comments in the archive file. The archive file might have at least some of the following information embedded in it: Account ID; Snapshot date; Last edit date; etc.

In at least some embodiments consistent with the present invention, a user can import an old archive file into any account in the LAEA. Doing so might automatically trigger synchronization operations. A user can archive a last posted version of account, and might be presented with a checkbox to include edits made since the last posting (deltas).

### Offline Use

It is expected that most user edits will be done offline. Consequently, in at least some embodiments consistent with the present invention, the default way of working with the LAEA will be offline. The user might be prompted for their username and password the first time they perform an action requiring access to the back-end operations (Recall, e.g., 320 of FIG. 3). Non-ICS users might be presented with a “remember me” checkbox. The user should be able to start the application while offline, select from the accounts available for editing, and edit them. An “Available for editing” indication means accounts there are currently in LAEA's local cache and are visible in the tree view. The user should be able to start working online, then go offline (e.g., due to a network failure) and continue working. If someone has made edits in a Web-based, online, front-end while the LAEA was offline, then when the user goes online, they can synchronize their account in the LAEA.

### Sharing Workflow

At least some embodiments consistent with the present invention permit customer service representatives to export a file that can easily be viewed by a customer. The file might contain one or more of the following columns for keywords: campaign; ad_group; keyword; keyword type; CPC; and destination URL. The file might contain one or more of the following columns for ad creatives: campaign; ad_group; headline; line1; line2; visible URL; and destination URL.

In at least some embodiments consistent with the present invention, multiple users can edit the ad account information in separate instances of the LAEA. The users can send suggested changes back and forth, until they agree. When changes to the account are agreed on, the account may be posted.

Embodiments, such as those just described, are useful and support various workflow scenarios. Consider, for example, the following scenario. A customer service representative opens an ad account in the LAEA, edits the account, and shares, with the customer, provisional changes along with comments. The customer opens the account in the LAEA, and sees the provisional changes, along with comments. The customer can (a) mark provisional edits as approved or rejected, (b) edit comments and share, and/or (c) edit provisional changes and either approve or share. These steps can be repeated as desired. For example, the customer can send their version back to the customer service representative (or someone else), for their comments and changes. The customer or the customer service representative can then post the final edits. As can be appreciated from the foregoing example, multiple iterations of editing and approval can be performed, with multiple users viewing changes, approving changes, and/or making changes.

A customer service representative might be able to leave comments so that the customer knows why certain changes were made. Comments might be provided in association with (e.g., at or adjacent to) one or more of the following: individual keyword; individual creative; ad_group; campaign; etc.

There might be a “view all comments” custom view.

In a comment custom view, a comment column might be emphasized (e.g., made larger).

A visual indicator might be provided on the tree-view to indicate that someone has left a comment (e.g., on information at a certain hierarchical level (e.g., campaign, campaign+ad_group, etc.) in the ad account).

There might be an option to clear all comments. Note that all comments might be cleared automatically when an ad account is posted, or edits are accepted.

### Multiple Add

Recall that some of the screen user interfaces included a “Multiple add” button. In at least some embodiments consistent with the present invention, the multiple add operations works within the scope of the selected ad_group only. The user might be able to import data (keywords, keyword changes, ad creatives, etc.) by copying and pasting from a spreadsheet (e.g., a bulksheet) or importing from a comma separated value or tab delineated value file. The user might be able to see some sample data in the first step of a wizard. It might be specified that the user can only enter one type of data in each column. A checkbox for “Delete any items in the ad_group that do not exist in pasted rows” might be provided.

If the user is trying to import keywords, the columns that the user is trying to import might be automatically determined. The user might be able to modify column type assumptions before loading. On the other hand, for ad creatives, the user might be forced to follow a fixed column format.

Items might be automatically selected after importing. In this way, users can easily manipulate such items.

Once the user selects a “submit” operation, the LAEA might try to match the imported data to the data in the system, and identify new items, and existing items. The LAEA might then display a result view containing (1) new items that do not exist in the ad_group and (2) existing items. For existing keywords, the user might be permitted to either (A) modify the existing keywords (change CPC, destination URL, keyword type, etc.), or (B) delete the keyword. The user might be permitted to then apply all changes, deselect certain changes and apply the remaining ones, or cancel the entire operation. If a column has a blank entry (e.g., if a keyword has a blank CPC), that entry might not be modified.

### Advanced URL Updates

At least some embodiments consistent with the present invention might allow the user to perform various changes to the destination URL on all selected keywords or creatives. For example, the user might be permitted to specify a base URL that will be in all of the destination URLs. As another example, the user might be permitted to find and/or replace a term within a URL. As yet another example, the user might be permitted to add variables within URL

### Advanced CPC Changes

At least some embodiments consistent with the present invention might permit the user to apply advanced CPC changes to all currently selected keywords. Examples of such advanced CPC changes include: set all max cpc's to ______; change all max cpc's by ______ (add or subtract a value); change all max cpc's by ______ % (multiply by a positive or negative percentage), etc.

### Creative Previews

Screens corresponding to the keyword tab 631 and the text ad (or creative) tab 632 might include a preview box showing an ad creative as it will be rendered to end users. (See, e.g., FIG. 11.) In the text ad (or creative) tab 632, the preview box might show the currently selected creative. In the keyword tab 631, the preview box might show a creative, with forward and backward buttons, allowing the user to loop through all the creatives corresponding to the selection.

### Custom Views and Search

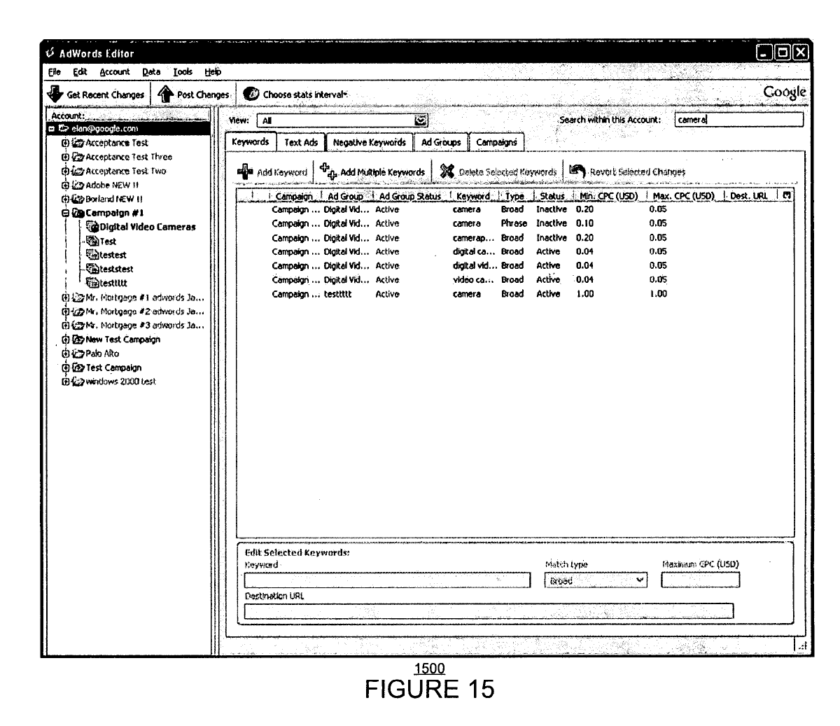

In at least some embodiments consistent with the present invention, search is performed on the currently selected scope as the user enters search query information into the text box 620. (See, e.g., FIG. 15, described below) “Custom views” (e.g., a search that the user can name and save) might be performed on the currently selected scope. The last X (e.g., the last 5) searches might be automatically saved. Results views might show campaign and ad_group columns. Special custom views might include warnings and errors, all changes since last post (deltas, plus, minus), etc.

An advanced search tool might be provided. With such an advanced search tool, users can multi-select from the list of campaigns and ad_groups, and then create a series of filters based on statistics such as impressions, CPC's, cost, click-through rate, conversion rate, etc.

### Styling, Errors, and Error Messages

In at least some embodiments consistent with the present invention, styling errors and/or error messages may be provided in a cascading style sheet (CSS) file. Different errors might be presented differently for different portions—e.g., tree view, tabs, menus, etc.—of a user interface display screen.

In a tree view, campaigns and ad_groups might be marked if there are changes, warnings, or errors within it. Changes might be marked with bold. Errors/warnings might be marked with an icon on the folder/ad_group icon. Deleted campaigns/ad_groups might be indicated by a grayed-out folder or grayed-out and struck-out text, for example. Paused campaigns/ad_groups might be grayed-out (folder and text).

In a table view, changed cells might have their text bolded. Deleted cells might be grayed-out with a strikethrough. Errors/warnings might be marked with an icon on the row, and the specific cell might be provided with a light red (or some other color) background color. In the edit pane, the error text field might have a light red (or some other color) background color and might contain the error text. A tool tip for the error icon on the row might contain the error text.

If multiple items are selected, error might be indicated as follows. If all selected item have the same error, the error(s) might simply be shown. If all selected items have a least one common error(s), but some selected items have additional error(s), the shared errors(s) might be shown and a message indicating that some selected rows have additional errors might be provided. If only some of the selected items have errors, then the user might be informed that some selected rows have errors.

View menu options might include (1) view all, (2) view changes, and (3) view errors.

Conflicts between edits made at the server (e.g., via a Web-based front-end editor) and LAEA might be indicated.

Naturally, changes, errors, warnings, etc. might be presented to the user in ways other than those described above.

### Tools

At least some embodiments consistent with the present invention might include various tools. One exemplary tool is to find all duplicate keywords. Other exemplary tools include, for example, keyword expansion, etc. An ad grouper tool which groups similar keywords into their own ad_groups might be provided.

### Separate Content Bids

Some entities, such as Google for example, allow advertisers to advertise in different ways. For example, an advertiser may advertise on Google's search result page using AdWords and/or on publishers participating in Google's AdSense contextual advertising network. At least some embodiments consistent with the present invention permit the user to specify a separate ad_group level CPC bids for the content advertising network (e.g., AdSense) and a search keyword advertising network (e.g., AdWords).

### Drag and Drop & Clipboard

### (Ctrl-C, Ctrl-V, Ctrl-X)

At least some embodiments consistent with the present invention provide drag and drop and clipboard (e.g., cut and paste or copy and paste) functionality for one or more of keywords, creatives, and negative keywords. These operations may include user dialog depending on a characteristic of the item being manipulated. For example, dragging a new item might not trigger any dialog. Dragging an item with history might cause the user to be asked if they want to move and lose history, or copy. Dragging a keyword onto a campaign might cause the user to be asked:
Copy to all ad_groups?
Move to new ad_group? (If item has history, then ask if user is sure they want to move and lose history.)
Copy to new ad_group?

At least some embodiments consistent with the present invention permit the user to drag negative keywords to and/or from campaign level and ad_group level.

A CTRL-drag operation might copy the item.

At least some embodiments consistent with the present invention might allow items to be cut-copy-paste (by CTRL-X CTRL-C CTRL-V) between ad_groups, or even within an ad_group.

At least some embodiments consistent with the present invention provide drag and drop and clipboard (e.g., cut and paste or copy and paste) functionality for ad_groups. For example, the user might be permitted to move an ad_group into another campaign by dragging (from ad_group tab or tree view). As another example, the user might be permitted to copy an ad_group by CTRL-dragging. If the user moves an ad_group with a history, the user might be asked if they want to move and lose history. A function allowing users to specify multiple campaigns to which the ad_group will be copied might also be provided. Moving an ad_group might recursively copy all of the ad_group's children, but not delete the children. Alternatively all children of deleted ad_groups might be marked as deleted.

Selecting keywords and right-clicking might invoke a menu for creating new ad_group with the selected keywords. This action might create a new ad_group in the currently selected Campaign, and moves the selected rows into the new ad_group. The new ad_group might be given a default name, e.g. “New Ad_group X”.

In at least some embodiments consistent with the present invention, information in selected rows may be moved and/or copied to an ad campaign, and/or an ad_group by “dropping” or “pasting” such rows into an appropriate node in the hierarchical tree view 690.

### Local Error Checking

Errors in ad account information may be checked locally on a user client device, or at a central location. Local error checks may include one or more of the following items or classes of items.

Missing Contained items (e.g., ad_group missing ad text or keywords, campaign missing ad_groups, etc.) might be checked locally.

Missing Content (e.g., campaign name & settings, ad_group name & setting, ad text, visible URL, destination URL, no keyword text, etc.) might be checked locally.

Bad Values (e.g., campaign name illegal, CPC too large, bad campaign budget (negative, non-numeric, etc.), bad destination URL, extra /, missing http(s), destination URL has illegal characters, destination URL includes space, etc.) might be checked locally.

Whether too many of a certain items have been entered (e.g., too many characters in creative rows or keywords, too many total keywords (must delete words to add words), too many words in a keyword, the user tries to create too many campaigns/ad groups (show message: “Please contact customer support” unless the user downloads an ad account with over 25 campaigns) might be checked locally.

Whether a positive keyword matches a negative keyword might be checked locally.

Incorrect spacing in ad text might be checked locally.

Forbidden character(s) (e.g., #, %, !, etc.) might be checked locally.

Other ad serving system policies (e.g., “google” used in ad text) might be checked locally.

Errors found in a local error check should be indicated to the user.

A local error check might be run before updated account information is posted, before the ad account information is sent to a customer service representative or another user, as the user enters data, etc.

### Validation

In at least some embodiments consistent with the present invention, the user cannot post their account until going through a validation process. The validation process might send only non-benign changes through a centralized policy checking facility (See, e.g., U.S. patent application Ser. No. 11/026,415 (incorporated herein by reference and referred to as “the '415 application”), titled “IMPROVING ADVERTISEMENT APPROVAL,” filed on Dec. 30, 2004 and listing Gregory Joseph BADROS, Robert J. STETS, and Lucy ZHANG as inventors) and might return the status (Ok, Warning, or Error Code) for such non-benign changes. CPC and keyword type changes might be considered to be benign and therefore might not need validation. New or modified creatives, URLs, and keywords, might be considered to be non-benign and therefore might require validation. New negative keywords might be considered to be benign and therefore might not need to be validated. Note that local error checking, just described above, may advantageously reduce the load on, and responsibilities of the centralized, policy checking (e.g., of the ad server).

Once something has been validated, it should not be re-validated unless it has been changed.

Graphical representations marking an ad_group or a campaign or keyword or creative might be provided to indicate that the item is: not yet validated; has been successfully validated; has an error; or has a serious error including a warning.

Server-side policy checking might take considerable time. Consequently, it might be useful to provide one or more of the following. It might be useful to provide a progress indicator. It might be useful to validate only one account at a time. It might be useful to disable user editing of ad account information while validation is proceeding. (However, the user might be permitted to continue working on other accounts.) It might be useful to disable user editing while posting is in progress, though reading account information (e.g., browse around the account) might be permitted. It would be useful to allow the user to interrupt the validation process. In this way, the user can continue working on the account, and then validate it later. Embodiments consistent with the present invention may provide one or more of the foregoing useful features.

### Exception Requests

If a user wishes to challenge a warning or error, embodiments consistent with the present invention might allow the user to request an exception. An example of this would be Reebok wanting to be able to use the trademarked term “Reebok” in their ads. There are many types of possible exception requests. A reviewing representative of the ad serving system might determine if the exception is to be a one-time exception or a permanent exception, and mark the ad account accordingly.

If the error is an error that can have an exception request, then a button such as “Submit Exception Request” might be shown in the edit plane of the user interface screen. Such a button might open a dialog box where user can enter an exception request. The user might be able to apply same exception request to multiple selected items. After the exception request is posted, the contents of the exception request dialog might be wiped out and the dialog box might be closed.

The dialog box might contain specific text fields to enter exception requests for each item requiring an exception request. For example:
Submit exception request for: Coke [ ]
Submit exception request for: Sprite [ ]
[Save] [Apply]

On apply, the same exception request might be attached to all fields with the same error containing the same offending word.

FIG. 14 illustrates an exemplary exception request dialog box.

### Preferences

Some embodiments consistent with the present invention might allow users to enter preferences. Examples of such user preferences are described below. A user might be provided with the option to hide various items, such as:

[ ] Hide all deleted items (default on)
[ ] Hide deleted creatives
[ ] Hide deleted campaigns
[ ] Hide deleted ad groups

[ ] Download deleted campaigns (default off)

The user might be permitted to set default values for new campaigns, such as:
Location: USA, France, +X edit
Language: English, French, +Y edit

The user might be permitted to set default Ad_group Max CPC, etc. The user might be permitted to always show certain columns (e.g., Campaign/Ad_group Columns).

### Internationalization

All user interface text and messages might be parameterized for easy internationalization. For example, different currencies might be provided in association with items having a monetary value (e.g., CPC bids).

### Export View

Some embodiments consistent with the present invention might permit the user to select any custom view, and export it to printable preferred format (e.g. HTML, PDF, DOC, etc.). This may be useful for customer or legal approval of an ad campaign before it is posted.

The user might be able to export a custom view into a comma separated value, or tab delineated value file for import into Excel for their own manipulations.

The user might be able to export one or more of a custom view, an ad_group or ad_groups, a campaign or campaigns, a whole account, etc. The user should be able to specify what elements they want included in the export. Elements able to be specified might include keywords (and any of the following: type, CPC, destination URL), text ads (either row or AdWords box format), image ads, performance statistics (user can select from Impressions, Clicks, CTR, Cost, Conversion, etc.), etc.

The user might be permitted to modify the template for the exported document.

Such modifications might include adding their company name and address, adding their logo, selecting colors, selecting fonts, using their own CSS stylesheet, etc.

### Extensions/Plug-in Mechanism

Some embodiments consistent with the present invention might permit third parties (e.g. third party tool developers) to write extensions that do various things such as reporting/charting (e.g., report center API calls), bid changes, destination URL changes, integration with third party data sources (e.g. an inventory management system) tools (e.g., traffic estimator, keyword suggestion, etc.), etc. For example, third parties might be permitted to do anything allowed by the API. Third parties might be permitted to create new tabs. Third parties might be permitted to create new windows, wizards, etc.

### Event Scheduler/Task Bar Service

Embodiments consistent with the present invention might permit the user to schedule events at specific times. Operations that can be done at each event might include CPC changes (e.g., for specified keywords, for entire ad_groups, etc.) pause/un-pause (e.g., ad campaigns, ad_groups, etc.), etc.

The schedule task bar service might run in the background even if the LAEA is not running. The events might be controlled by the LAEA scheduler on the user's local machine. Consequently, the user's local machine might need to be up and running for events to be recognized and trigger scheduled actions.

### Change History Logging

In at least some embodiments consistent with the present invention, all changes made to the ad account using the LAEA will be logged in a change history and will reflect that the change was made by an the LAEA user. The time when the account was posted might be used to timestamp the logged change.

### Statistics/Dashboard

At least some embodiments consistent with the present invention may monitor various statistics. These statistics may be presented to a ad serving system personnel (e.g., in the form of a desktop “dashboard”). Such statistics may include one or more of:
Number of the LAEA clients downloaded;
Number active in last 30 days;
Number of crashes/failures;
Number of actions (either API calls or some other statistic);
Number of account downloads/validations/postings;
Number of accounts managed using LAEA;
Revenue managed using LAEA;
Change in account spend after starting to use LAEA; and
Number of customer support requests.
   Note that these statistics are mainly for internal use by the ad serving entity.

### Account Counts (Tool Menu Item)

Similarly, at least some embodiments consistent with the present invention may monitor (e.g., count) various account information. This (count) information may be presented to the user (e.g., in the form of a desktop “dashboard”). Counts may include one or more of number of ad campaigns (Z active, Q pending, H ended, X paused, Y deleted, T suspended); number of ad_groups (Z active, X paused, Y deleted), number of keywords (Y active, Z inactives), number of ad creatives (Y active, Z deleted, X disapproved), etc.

### Ad Account Structure and Information

Although some of the exemplary embodiments were described in the context of a particular advertising system having a particular structure (e.g., ad account->ad campaigns->ad_groups->ad creatives) with certain types of ad information (e.g., text ads, CPC bids, etc.), those skilled in the art will appreciate that various features described above can be easily applied to other types of advertising systems having different structures (flat, other hierarchies, etc.) and/or different types of ad information (e.g., audio ads, video ads, ads with different types of bids or offers such as offer per impression, maximum offer per impression, offer per conversion, maximum offer per conversion, etc., with different types of targeting such as vertical product categories, Websites, etc., etc.)

Further, although some of the exemplary embodiments were described in the context of a user interface display screen having certain sections arranged in a certain layout, those skilled in the art will appreciated that various features described above can be applied to other display screens.

Examples of Operations in an Exemplary Embodiment Consistent with the Present Invention

FIG. 11 is an exemplary screen 1100 of an exemplary user interface consistent with the present invention which shows a full ad account scope (all ad campaigns and ad_groups) and a text ad tab 632 selected. As shown, the user selected a text ad as indicated by the highlighted row. The expanded view below the table allows the selected text ad to be edited. A preview section shows the ad as it should appear on Web pages.

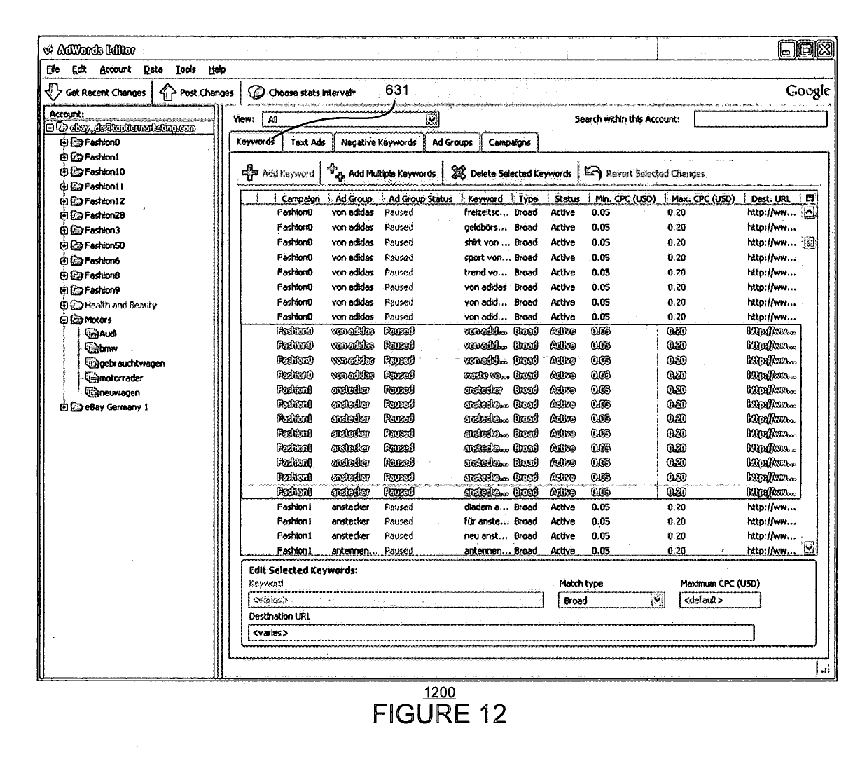

FIG. 12 is an exemplary screen 1200 of an exemplary user interface consistent with the present invention which shows full ad account scope (all ad campaigns and ad_groups) and a keywords tab 631 selected, and corresponding multiple items that cross multiple campaigns and ad_groups selected in the table. As indicated by the editing section below the table, multiple changes, across multiple campaigns and ad_groups, may be made at once.

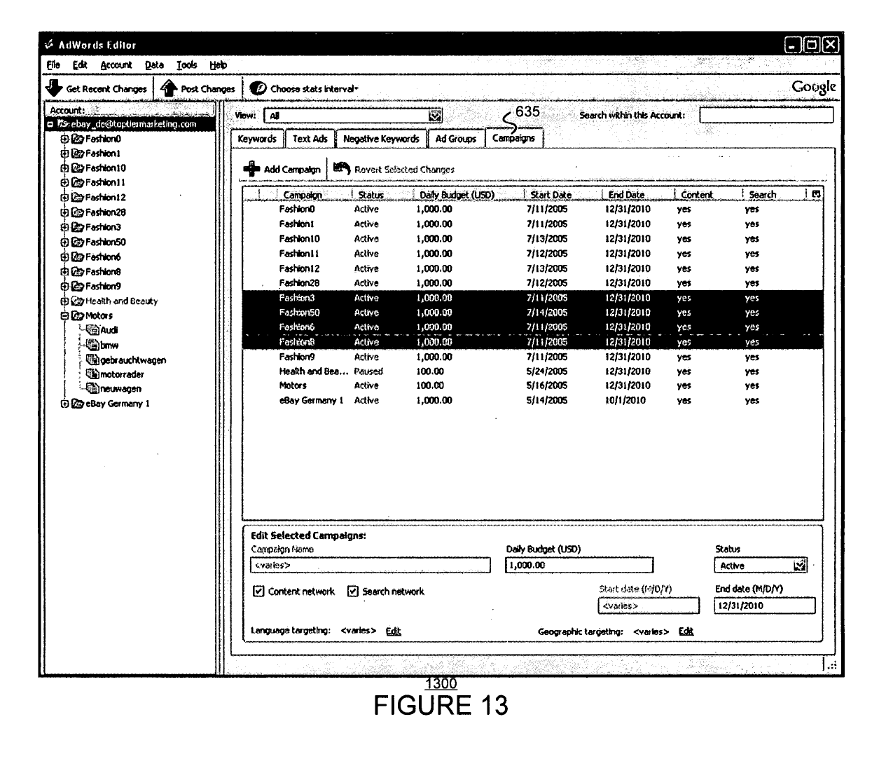

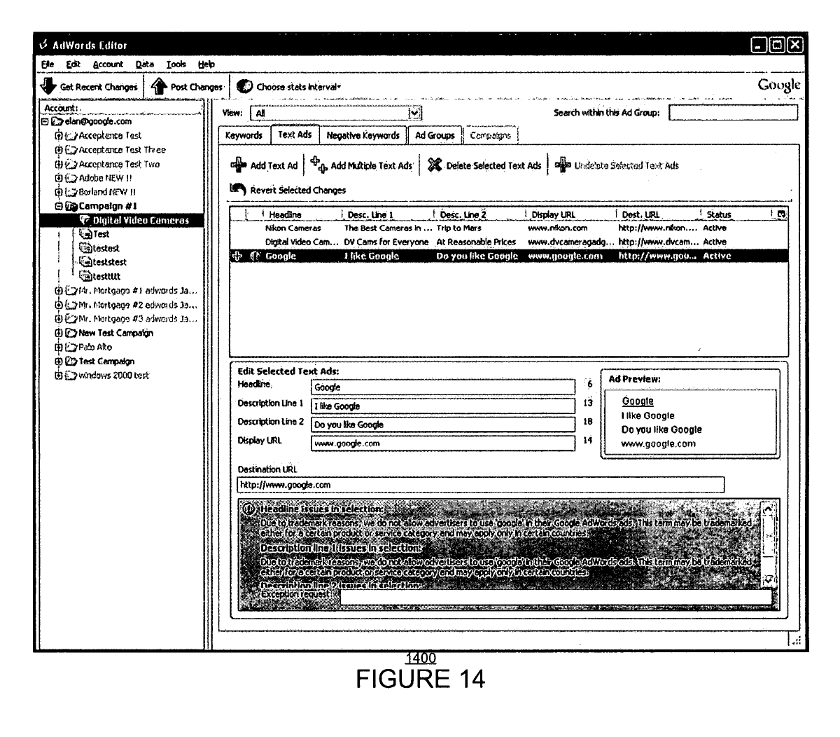

FIG. 13 is an exemplary screen 1300 of an exemplary user interface consistent with the present invention which shows full ad account scope (all ad campaigns and ad_groups) and a campaigns tab 635 selected. Corresponding items are shown in a table. Information in the selected rows of the table may be edited via the editing section below the table.

FIG. 14 is an exemplary screen 1400 of an exemplary user interface consistent with the present invention which shows error notification and the ability to make an exception request. In this example, it is against a policy of the ad serving system to serve text ads with the term “Google”.

FIG. 15 is an exemplary screen 1500 of an exemplary user interface consistent with the present invention which shows full ad account scope with search results for keywords matching the search term “camera” entered in the search box 620. Notice that the tree view might indicate ad campaigns and/or ad campaigns+ad groups which include the search results.

### CONCLUSIONS

As can be appreciated from the foregoing, embodiments consistent with the present invention allow advertisers and/or customer service representatives to easily and efficiently view, navigate, and edit ad accounts, even those with large numbers of campaigns, ad_groups, keywords and creatives. Consequently, such embodiments should increase customer satisfaction, and significantly reduce customer support costs.

1.-21. (canceled)

22. A method for managing conflicts of keywords associated with a content account for one or more advertisement campaigns, comprising:
receiving, by a client device, one or more keywords associated with the content account from a computer system via a communication network, wherein content associated with the content account is selected by the computer system for display based on at least one of the one or more keywords;
obtaining, by the client device, a negative keyword associated with the content account via an input interface of the client device;
determining, by the client device or the computer system, a match between the negative keyword and a keyword of the one or more keywords; and
providing, by the client device, a representation of a conflict on a user interface associated with the content account responsive to determining the match.

23. The method of claim 22, wherein the representation of the conflict comprises a selectable option for removing the conflict associated with the match between the negative keyword and the keyword of the one or more keywords.

24. The method of claim 23, wherein the representation of the conflict comprises a selectable option for removing the negative keyword from at least one of the content account, an advertisement campaign of the one or more advertisement campaigns, and a content group associated with one of the one or more advertisement campaigns, wherein the content group is a sub-category within the respective advertisement campaign.

25. The method of claim 22, wherein the representation of the conflict comprises a selectable option for keeping the negative keyword despite the conflict.

26. The method of claim 22, wherein the representation is automatically provided in response to receiving the negative keyword.

27. The method of claim 22, wherein the representation includes an indication of an action to resolve the conflict.

28. The method of claim 22, wherein the representation includes a selection for adding the negative keyword in the content account.

29. A computer system, the system comprising:
a memory storing computer executable instructions for managing conflicts of keywords associated with a content account for one or more advertisement campaigns; and
at least one processor that executes the computer code instructions and causes a computer device to:
receive, from a computer system via a communication network, one or more keywords associated with the content account, wherein content associated with the content account is selected for display based on at least one of the one or more keywords;
obtain a negative keyword associated with the content account via an input interface of the computer device;
determine a match between the negative keyword and a keyword of the one or more keywords; and
provide a representation of a conflict on a user interface associated with the content account responsive to determining the match.

30. The system of claim 29, wherein the representation of the conflict comprises a selectable option for removing the conflict associated with the match between the negative keyword and the keyword of the one or more keywords.

31. The method of claim 30, wherein the representation of the conflict comprises a selectable option for removing the negative keyword from at least one of the content account, an advertisement campaign of the one or more advertisement campaigns, and a content group associated with one of the one or more advertisement campaigns, wherein the content group is a sub-category within the respective advertisement campaign.

32. The system of claim 29, wherein the representation of the conflict comprises a selectable option for keeping the negative keyword despite the conflict.

33. The system of claim 29, wherein the representation is provided in response to receiving the negative keyword.

34. The system of claim 29, wherein the representation includes an indication of an action to resolve the conflict.

35. The system of claim 29, wherein the representation includes a selection for adding the negative keyword in the content account.

36. A non-transitory computer-readable storage medium having computer code instructions encoded thereon, wherein the computer code instructions, when processed by a processing circuit, perform steps comprising:
receiving, from a computer system via a communication network, one or more keywords associated with a content account, wherein content associated with the content account is selected for display based on at least one of the one or more keywords, and wherein the content account stores information associated with one or more advertisement campaigns;
obtaining a negative keyword associated with the content account via an input interface;
determining a match between the negative keyword and a keyword of the one or more keywords; and
providing a representation of a conflict to a user interface associated with the content account responsive to determining the match.

37. The computer-readable storage medium of claim 36, wherein the representation of the conflict comprises a selectable option for removing the conflict associated with the match between the negative keyword and the keyword of the one or more keywords.

38. The computer-readable storage medium of claim 37, wherein the representation of the conflict comprises a selectable option for removing the negative keyword from at least one of the content account, an advertisement campaign of the one or more advertisement campaigns, and a content group associated with one of the one or more advertisement campaigns, wherein the content account and the content group is a sub-category within the respective advertisement campaign.

39. The computer-readable storage medium of claim 36, wherein the representation of the conflict comprises a selectable option for keeping the negative keyword despite the conflict.

40. The computer-readable storage medium of claim 36, wherein the representation is automatically provided in response to receiving the negative keyword.

41. The computer-readable storage medium of claim 36, wherein the representation includes an indication of an action to resolve the conflict.
